(19) United States
(12) Patent Application Publication
(10) Pub. No.: US 2020/0394583 A1
(43) Pub. Date: Dec. 17, 2020

(54) SUMMARY PATH IN AN INTERACTIVE GRAPHICAL INTERFACE

(71) Applicant: Smartsheet Inc., Bellevue, WA (US)

(72) Inventor: Prasad Pramod Sangekar, Bothell, WA (US)

(21) Appl. No.: 16/439,529

(22) Filed: Jun. 12, 2019

(51) Int. Cl. G06Q 10/06; G06F 9/451

(52) U.S. Cl. CPC G06Q 10/06316; G06F 9/451

(57) ABSTRACT

Methods to identify summary paths within specific parent task domains within a project enable the efficient computation and display of summary paths in Gantt or other project management structured user interfaces. These methods are computationally more efficient than conventional critical path computations and enable a finer-grained identification of critical tasks or sub-paths. User's may generate summary paths in specific parent domains and identify critical tasks and sub-paths therein faster, with lower computational overhead, and with fewer physical actions.

### BACKGROUND

Critical path is a concept that is well-known in project management. The critical path may be understood in a number of ways, one of which being the longest distance between the start and the finish dates of a project, taking into account all the tasks in the project and their maximum duration, which constrains the project meeting its deadline. Float, (also known as slack) describes how long a task can be delayed before it threatens the entire project's deadline. “Float” refers to how long the completion of a task may be delayed before the schedule deadline is impacted. Float is also referred to as “slack”. For example, if a task has a “float” of three days, then changing the end date for that task by two days will not affect the overall finish date of the project. However changing the end date of that task by four days will push out the date of the project completion. Tasks on the critical path are tasks that cannot be delayed without affecting the overall project finish date.

The critical path method employs a model of the project that includes a list of all of the tasks required to complete the project, the duration that each task will take to complete, and the dependencies between the tasks. Using this information, the critical path method calculates the longest duration sequence of planned tasks from the beginning to the end of the project and the earliest and latest that each task can start and finish without making the project longer. The process identifies tasks that are part of the longest duration sequence as “critical”. Thus, the longest duration sequence of planned tasks from the beginning to the end of the project is the “critical path”. In other words, the critical path is the sequence of planned tasks from the beginning to the end of the project which add up to the longest overall duration. The critical path determines the shortest time possible to complete the project. Any delay of a task on the critical path directly impacts the planned project completion date. See for example patent publication number US20130144679A1 by The Boeing Company.

### BRIEF SUMMARY

The length and complexity of some projects requires a more detailed way to identify critical tasks, but only within a particular branch of the project. Summary path identifies the path from a parent row down to all levels of subtasks that roll up to that parent, instead of scanning across the entire project. After summary path is enabled on a parent row of a project (e.g., by right-clicking any parent row in a Gantt chart and selecting Show summary path), the system identifies the critical, zero-float tasks traversed from last-finisher tasks up through dependency chains to the parent task, and highlights them on display of the Gantt chart. Any delay in these critical tasks results in the parent task completion being delayed. The algorithm is more computationally efficient and more constrained than conventional critical path approaches, and reveals and highlights different information. The algorithm is flexible and uncomplicated.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 in accordance with one embodiment.

FIG. 2 illustrates a summary path generation algorithm 200 in accordance with one embodiment.

FIG. 3 illustrates a child task set generation algorithm 300 in accordance with one embodiment.

FIG. 4 illustrates a last-finisher child task set generation algorithm 400 in accordance with one embodiment.

FIG. 5 illustrates a child task dependency graph generation algorithm 500 in accordance with one embodiment.

FIG. 6 illustrates a summary path algorithm launch control 600 in accordance with one embodiment.

FIG. 7 illustrates a contrasted summary path 700 in accordance with one embodiment.

FIG. 8 illustrates a contrasted summary path 800 in accordance with one embodiment.

FIG. 9 illustrates a contrasted summary path 900 in accordance with one embodiment.

FIG. 10 illustrates a contrasted multi-domain critical element 1000 in accordance with one embodiment.

FIG. 11 is an example block diagram of a computing device 1100 that may incorporate embodiments of the present invention.

### DETAILED DESCRIPTION

Embodiments of an algorithm disclosed herein provide project managers the ability to identify paths that may not be overall critical, but may have high impact if tasks within the project slip, for one or more branches of the overall project. These paths may be contrasted in a structured project management user interface. “Structured project management user interface” refers to a specific configuration of user interface elements on a machine display, with functionality integral to the configuration of those elements. This algorithm differs from conventional critical path analysis and is referred to herein as “summary path” analysis.

The summary path algorithm differs from conventional critical path approaches in a number of respects. The algorithm identifies zero slack sub-tasks within a parent task, even where the parent task has multiple branches, where any delay in the sub-task will impact the parent task. Slips in these sub-tasks or may not affect the overall critical path for the entire project, but will have an effect on the selected target parent task. Note that a task may be a task executed by a human being or a task executed by a machine (e.g., a software task or a manufacturing task).

Summary path collects all child tasks of a parent task, and filters out the tasks of this set that end last. Then a dependency graph is formed upwards through the parent branches from the last-finishing tasks, searching for and identifying zero float tasks. “Dependency graph” refers to a directed graph representing dependencies between tasks. A dependency graph may reveal an evaluation order or the absence of an evaluation order that respects the dependencies between tasks. If the scan of the dependency graph crosses a domain boundary of the parent task, the search for zero float tasks concludes on that branch of the parent task.

Whereas critical path algorithms typically scan forwards, from the root tasks of a project to its leaves, summary path begins with the last-finishing child tasks of a parent task within the project, scanning upward through the dependency graph. Unlike the critical path, which is the sequence of activities through an entire project having the longest duration, summary path need not comprise the longest path through a given parent task domain, and typically does not traverse an entire project. Further, critical path calculation is often a precursor to determining the float of tasks in the project, whereas determining the float of tasks is a precursor to determining summary path.

Throughout this disclosure reference is made to dates for tasks, such as finish dates. However it will be understood that tasks may also have times associated with them, both start and stop times for example. In some cases the start or stop time within a date may be utilized by the algorithms, for example to determine tie breaks between tasks finishing on a same date.

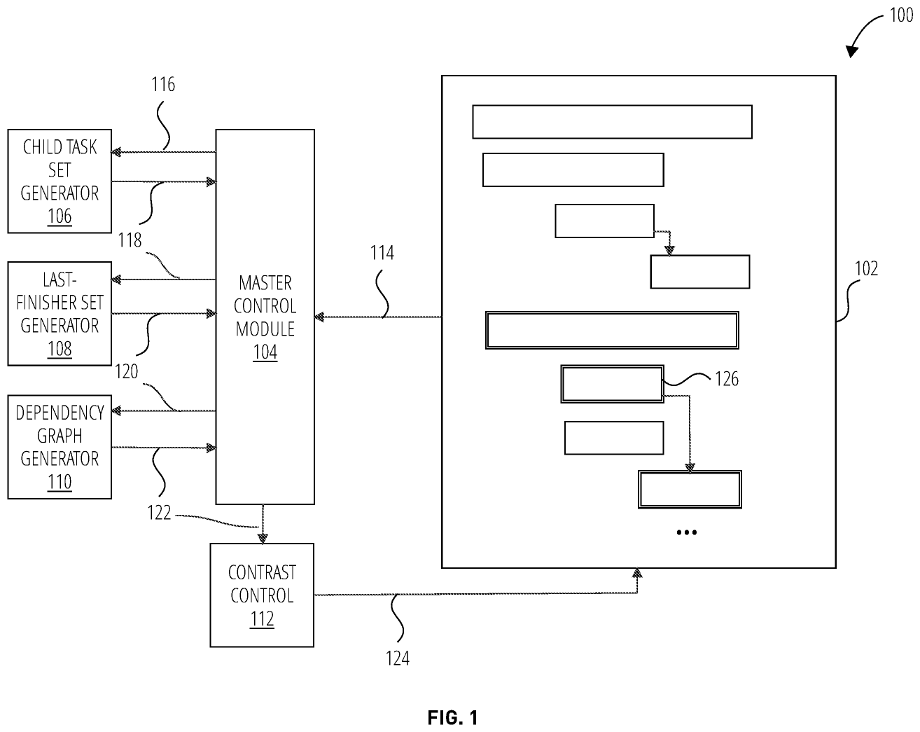

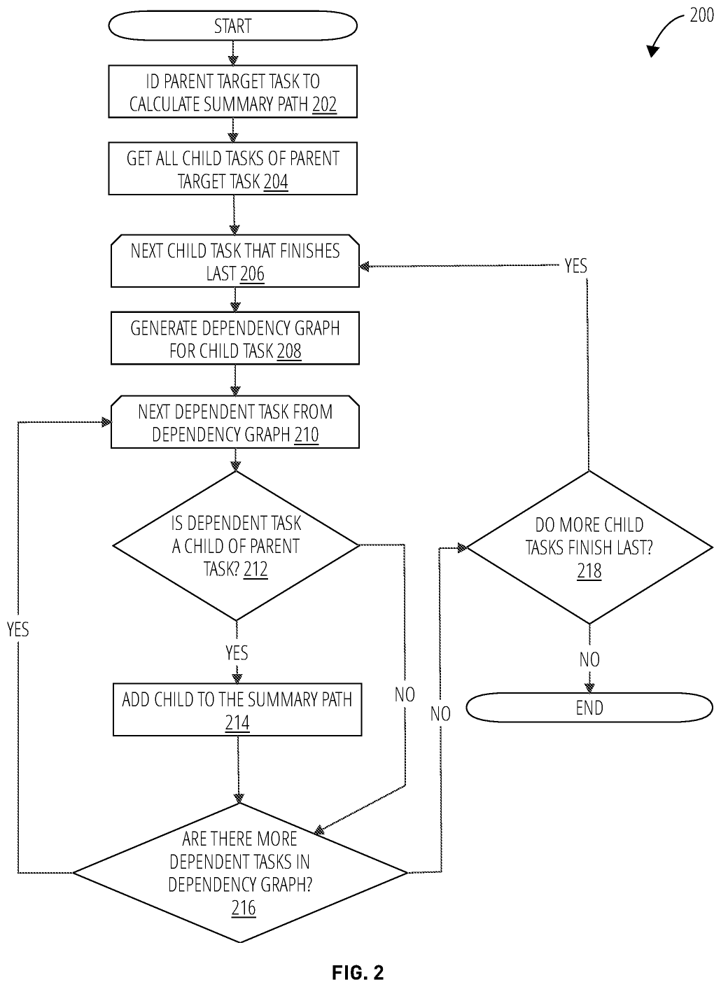

FIG. 1 illustrates a system 100 in accordance with one embodiment. The system 100 comprises a Gantt structure display 102, a master control module 104, a child task set generation module 106, a last-finisher set generator 108, a dependency graph generator 110, and a contrast control 112. Such a system 100 may be configured to carry out the summary path generation algorithm 200 described in FIG. 2.

Algorithms for the child task set generation module 106, last-finisher set generator 108 and dependency graph generator 110 are described in subsequent figures. The master control module 104 coordinates and controls these algorithms to generate a summary path.

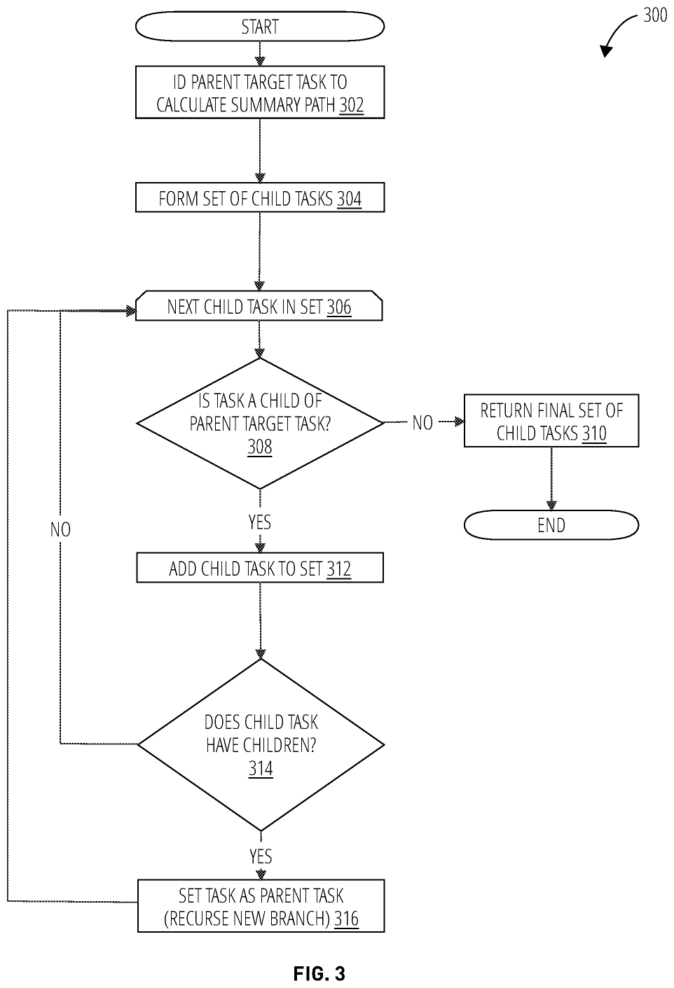

The master control module 104 may contain logic that scans the Gantt chart data 114 structure that underlies the Gantt structure display 102. When a particular task is selected within the Gantt structure display 102 and a summary path is requested, the master control module 104 may feed the Gantt data and selected task 116 to a child task set generation module 106. This module may detect the set of child tasks 118 falling under the selected parent task using the child task set generation algorithm 300 illustrated in FIG. 3. The child task set generation module 106 may return the set of child tasks 118 to the master control module 104.

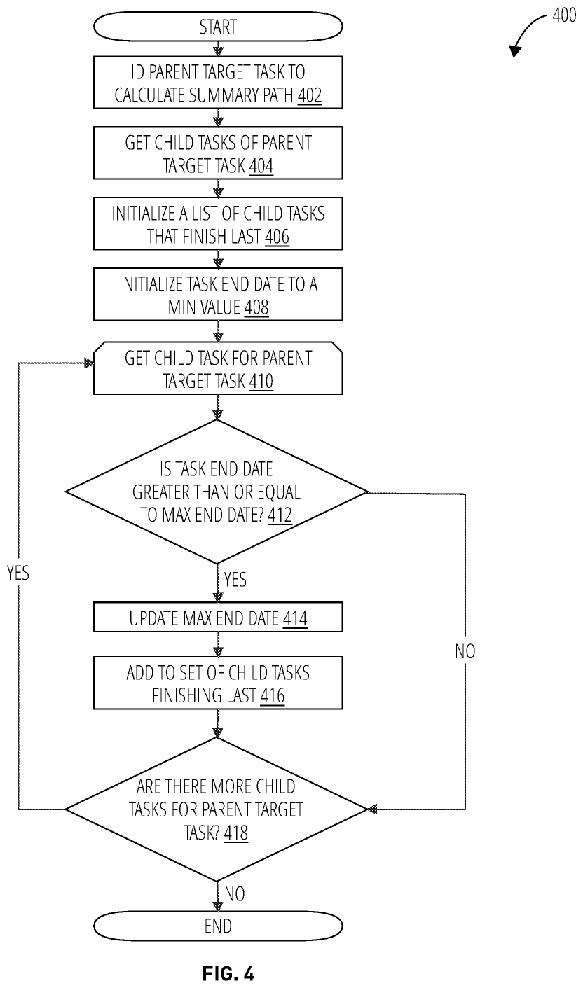

The master control module 104 may next feed the set of child tasks 118 to the last-finisher set generator 108. The last-finisher set generator 108 may calculate which of the child tasks are last-finisher tasks, using the last-finisher child task set generation algorithm 400 illustrated in FIG. 4. The set of last-finisher child tasks 120 may be returned to the master control module 104.

Among all sub-tasks of a parent task, the sub-task order may not be the same as the order in the sub-tasks finish. A last finisher is a sub-task with a latest end date. Multiple tasks can finish last. “Last” is determined based on the time sub-tasks finish, and multiple sub-tasks may finish at the same time and therefor “last”. One aspect of the summary path algorithm is that it does not utilize sorting of sub-tasks into any absolute order, which is more computationally efficient in computer systems over conventional approaches that utilize sorting.

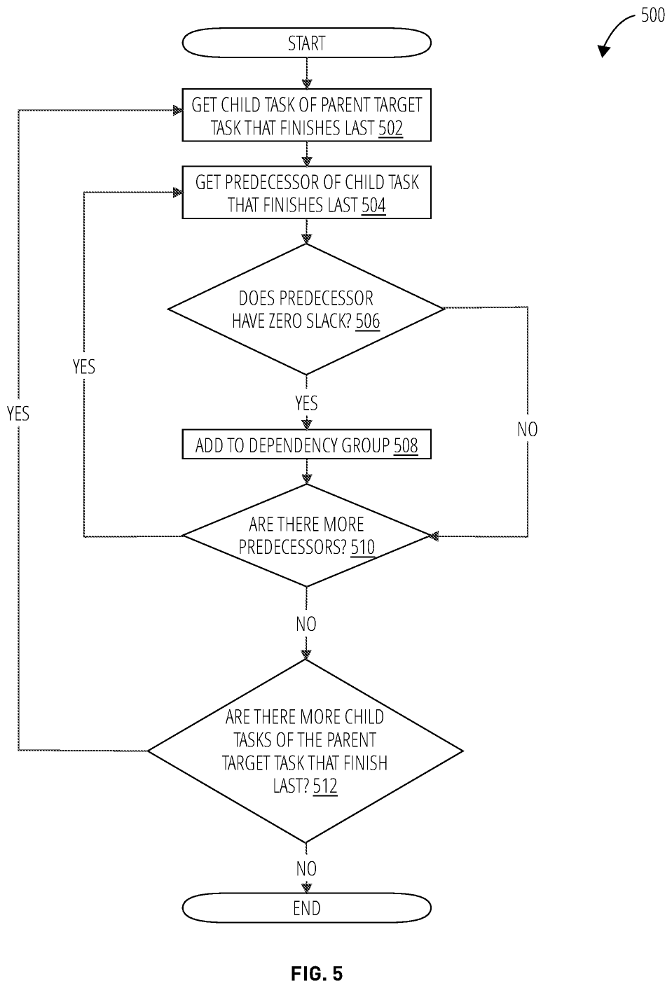

The master control module 104 may next feed the set of last-finisher child tasks 120 to the dependency graph generator 110. The dependency graph generator 110 may develop a dependency graph 122 based on the child task dependency graph generation algorithm 500 illustrated in FIG. 5. The dependency graph 122 so generated may then be returned to the master control module 104.

Finally, the master control module 104 may send the dependency graph 122 to the contrast control 112 module. The contrast control 112 module may append an attribute to the tasks within the dependency graph such that, when the tasks with contrast attribute 124 are fed back to the Gantt structure display 102, the tasks that comprise the dependency graph 122 appear in contrast to the other tasks shown in the Gantt structure display 102. This display contrast 126 may involve changing the color of the bars representing the tasks in the dependency graph, changing the line color and weight outlining those bars, presenting a highlighted area around the bars, etc.

FIG. 2 illustrates a summary path generation algorithm 200 in accordance with one embodiment.

In step 202, the parent target task is identified. This is the task which a user has selected and requested that a summary path be computed for. The parent task may be the top-level project task, but more typically is one or more task within the project.

In step 204, all of the immediate child tasks of that parent target task are identified using for example the algorithm illustrated in FIG. 3. Of these tasks, in step 206, a last-finisher child task is identified using the algorithm illustrated in FIG. 4. A last-finisher child task is the last task to finish, in terms of date and time, not necessarily the last task in an ordered set. For example, if three tasks X, Y, and Z, underneath parent task A, begin on dates Dec. 30, 2019, Dec. 31, 2019, and Jan. 1, 2020, and end on dates Dec. 31, 2019, Jan. 15, 2020, and Jan. 2, 2020, respectively, task Z may fall last in order, if tasks are ordered by their start date, but task Y would be the last-finisher, based on its later end date.

In step 208, a dependency graph is generated for the last-finisher child task using for example the algorithm illustrated in FIG. 5. The dependency graph may be generated from an unsorted set of tasks, a distinct advantage for computational efficiency on most computers and devices. From the dependency graph, dependent tasks may be identified in step 210, based on indicators of dependency between each dependent task. “Dependent task” refers to a task that's start depends on completion of a preceding task. As each dependent task is assessed, it is determined whether or not it is a child of the parent task (decision 212). In step 214, dependent tasks that are determined to be children of the target parent task are added to the summary path. Tasks that have parents other than the selected target parent task are filtered out, even if they are in a branch of the parent task. For example, a task in a branch of tasks originating from the parent task is filtered out if it lies outside the parent task boundary due to being part of a different parent task. These actions are repeated until there are no more dependent tasks in the parent-constrained dependency graph for that particular last-finisher child task (decision 216).

By defining last-finisher child tasks based on completion date in time, rather than final position in an ordered list, there may be more than one last-finisher task within the set of child tasks belonging to the target parent task. For example, task N beneath the same parent task A that includes the children tasks X, Y, and Z, may begin on Dec. 1, 2019, but may also have the same finish date of Jan. 15, 2020 as task Y. In such a case, both task Y and task N would be last finisher tasks. Once all of the dependent tasks for a last-finisher child task are added to the summary task, the algorithm determines whether or not more last-finisher child tasks are under the selected parent target task (decision 218). If other last-finisher child tasks are detected, the algorithm returns to step 206. If no other last-finisher tasks are found, the algorithm ends.

FIG. 3 illustrates a child task set generation algorithm 300 in accordance with one embodiment.

In step 302, one or more parent target task is identified from which to calculate the summary path. In step 304, an initial set of child tasks for the parent target task(s) is formed. This set initially comprises all of the tasks which have a direct parent-child relationship to the target parent task(s). This set may be in the form of an unsorted set of tasks.

Some of the child tasks identified in step 304 may, of course, have children of their own. The child task set generation algorithm 300 proceeds to identify additional tasks in the parent path, i.e., tasks that are not the parent task or its direct children, beginning at loop 306. If there are no additional tasks of this type, the algorithm ends, as all child tasks of the selected parent target task(s) have been identified.

If there are additional tasks which might also be child tasks to the parent(s) by their relationship with the direct child tasks, the algorithm works recursively to identify them. Tasks in the set of additional tasks are identified individually in decision 308. If the task identified is a child of a parent target task in decision 308, it is added to the list of child tasks in step 312. If that task has children (decision 314), it is identified as a parent task for which the algorithm must be recursed (step 316). If the task does not have children, the next task in the additional tasks is analyzed.

For each dependent task, the algorithm evaluates whether the dependent task is outside the boundary of the parent task. When a child task is identified in decision 308 that is not a child within the boundaries of the parent target task, it is not added to the list of child tasks, even if it descends/depends from the parent task. If such a task is encountered during iteration, the final list of child tasks for the parent task is returned in step 310. The algorithm eventually ends when all child tasks in all paths of the selected parent task(s) have been identified, excluding tasks outside the boundaries of the parent task(s).

FIG. 4 illustrates a last-finisher child task set generation algorithm 400 in accordance with one embodiment.

In step 402, the parent target task selected for summary path calculation is identified. The child tasks of this parent task are collected in step 404. A subset of last-finisher child tasks is then initialized from the set of child tasks (step 406). This subset may initially be just the first task in the child task set.

In step 408, a task end date for the subset of tasks is configured. This value is iteratively updated as later finishing tasks are identified and eventually emerges from the algorithm as a maximum task end date value.

The child tasks in the set are then iterated at loop 410 to identify the child task(s) with the maximum end date. The end date for each child task is evaluated at decision 412. If the task end date is not greater than or equal to the current value of the maximum task end date, the algorithm loops (decision 418). If the task end date exceeds the current value of the maximum task end date, the maximum end date value is updated at step 414, and the task replaces the contents of the last-finisher task set (step 416). If the task end date equals the current value of the maximum task end date, the task is added to the last-finisher task set. The algorithm repeats from decision 418 until no additional child tasks are found.

Note that the set of last-finisher child tasks is not necessarily constrained within the domain boundary of the parent task. The constraint to the domain boundary is applied instead during the scan of the dependency graphs.

FIG. 5 illustrates a child task dependency graph generation algorithm 500 in accordance with one embodiment.

In step 502, the set of last-finisher child tasks of the selected parent target task are identified. In step 504, the predecessor of one of the set of last-finisher child tasks is detected. In step decision 506, the predecessor is evaluated for zero slack. Zero slack indicates that the predecessor task may not experience any delay without impacting its dependent tasks, i.e., the task represents a point in which the schedule has zero slack in it. If the predecessor task evaluated is identified as having zero slack, it is added to the dependency group in step 508. If it does not have zero slack, step 508 is skipped.

The algorithm then looks for additional predecessor tasks (decision 510). If other predecessors are found, the algorithm returns to step 504 and evaluates these for the zero slack condition. Once all predecessors have been evaluated, the algorithm determines whether there are additional last-finisher child tasks to evaluate (decision 512). If there are not, the algorithm ends. If there are, the algorithm repeats back to step 502, continuing to analyze backwards up the dependency branches of the parent task.

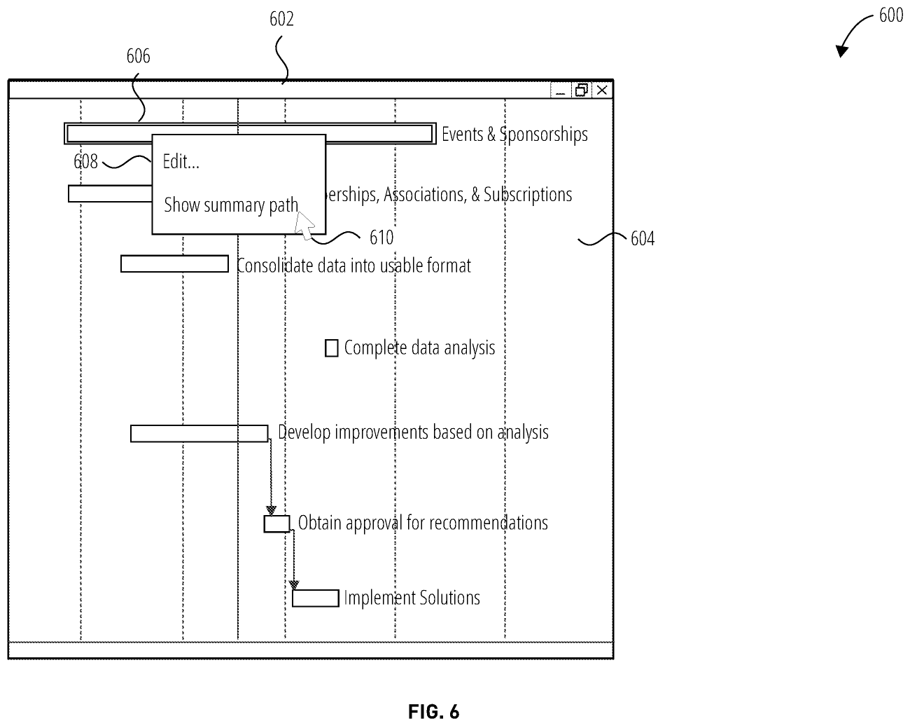

FIG. 6 illustrates a summary path algorithm launch control 600 in accordance with one embodiment. A structured project management user interface 602 provides a user with a means of visualizing and managing multiple stages of a project. In this example, a Gantt chart display window 604 is shown as part of an embodiment of a structured project management user interface 602 that is enabled to provide a summary path analysis.

In this embodiment, right-clicking with a mouse on a particular task may select that task as a target parent task 606. A dropdown menu 608 may then be displayed, including a summary path option 610. Clicking this option may execute the algorithms discussed herein upon the selected target parent task 606 to detect and generate a depiction on the Gantt chart display window 604 of a summary path.

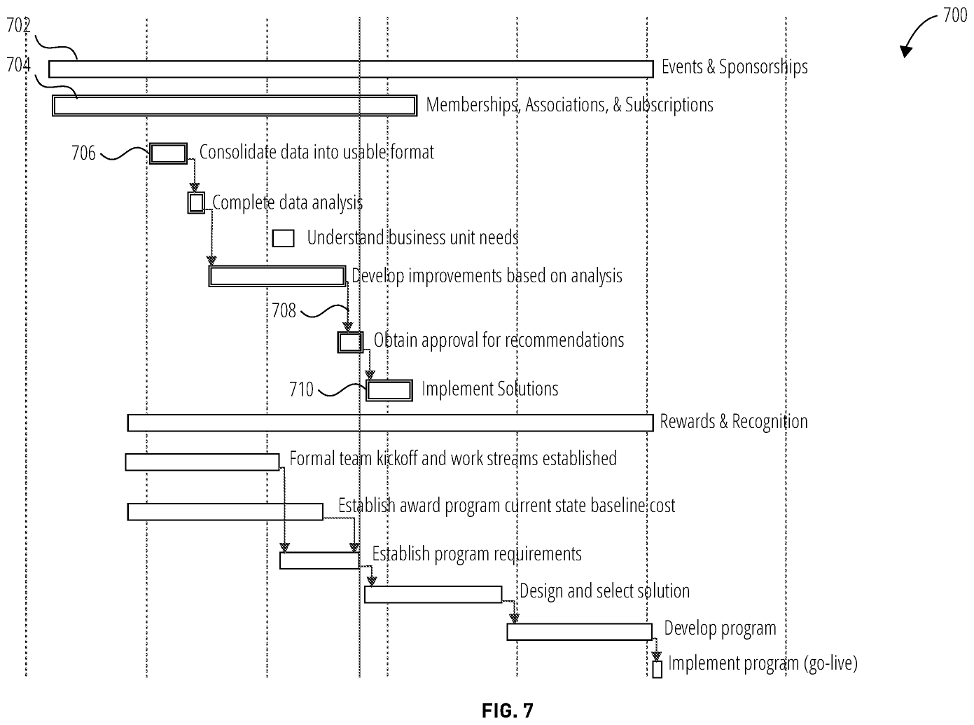

FIG. 7 illustrates a contrasted summary path 700 in accordance with one embodiment. In this example, an Events & Sponsorship project 702 includes a Memberships, Associations, & Subscriptions task, having a number of child tasks. This task may be selected for summary path analysis, and becomes the parent target task 704.

The algorithms described above may be run for the task tree beneath this parent target task 704. A summary path 706 may be identified by detecting a last-finisher child task 710, and working back up the dependencies of the last finisher to find a zero slack point 708. Because this zero slack point 708 is interposed between the Develop improvements task and the Obtain approval task, this path in the project may be identified as a summary path. The summary path for the selected parent target task 704 may be highlighted on screen as shown.

Other tasks shown finish later than the last-finisher child task 710 selected to calculate the summary path. But these tasks all depend from a different parent task (Rewards & Recognition) than the task selected as the parent target task 704. The Understand business unit needs task, while it does fall under the parent target task 704, is not involved in the dependency chain that includes the zero slack point 708, and thus is not included in the summary path.

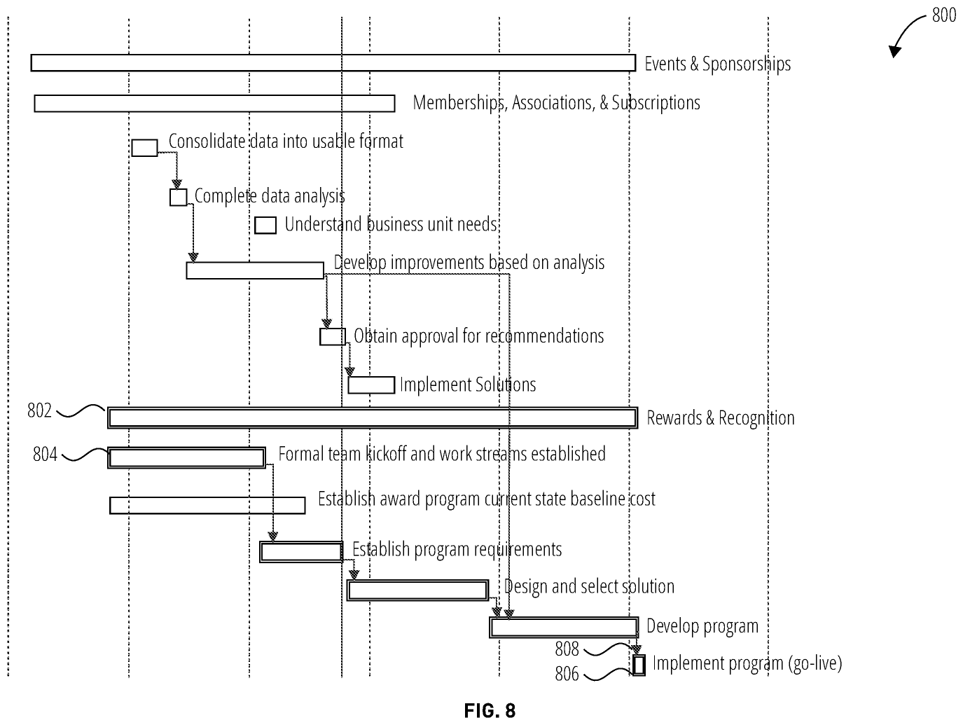

FIG. 8 illustrates a contrasted summary path 800 in accordance with one embodiment. In this example, the same general project structure is shown as in FIG. 7. However, in this case, the Rewards & Recognition task is selected as the parent target task 802 for calculating the summary path 804. The last-finisher child task 806 is identified, as associated with a zero slack point 808. The tasks within the dependency tree leading through the zero slack point 808 are highlighted as the summary path 804.

The task to Establish award program is not included, as it is not in the dependency chain that includes the last-finisher child task 806 and zero slack point 808. None of the child tasks of Memberships, Associations, & Subscriptions are considered, even though the Develop improvements task is part of the dependency chain through the zero slack point 808, because it falls outside the boundary of the selected parent target task 802.

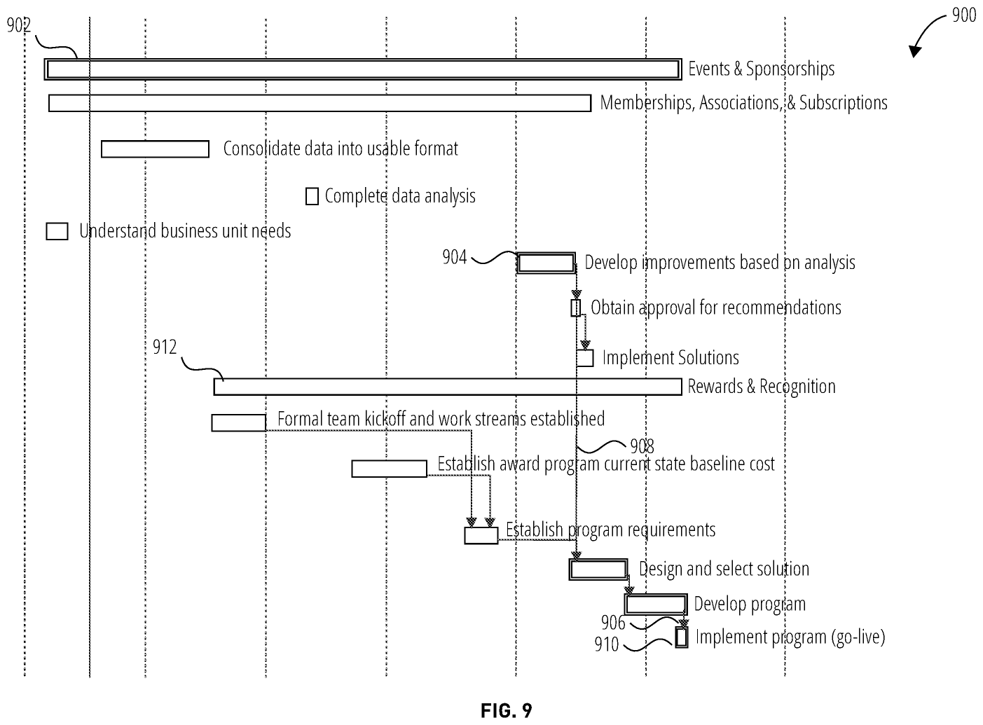

FIG. 9 illustrates a contrasted summary path 900 in accordance with one embodiment. In this example, Events & Sponsorship is selected as the parent target task 902. As this is the top-level parent of all of the tasks shown, all of these tasks are considered for inclusion in the summary path 904. One last-finisher child task 910 and one zero slack point 906 are identified.

There is a domain spanning dependency 908, in this case across the domain boundary 912 between the Develop improvements task and the Design and select solution task. Because the selected parent target task 902 includes both the Membership, Association, & Subscriptions and the Rewards & Recognition parent tasks, the summary path 904 spans these domains.

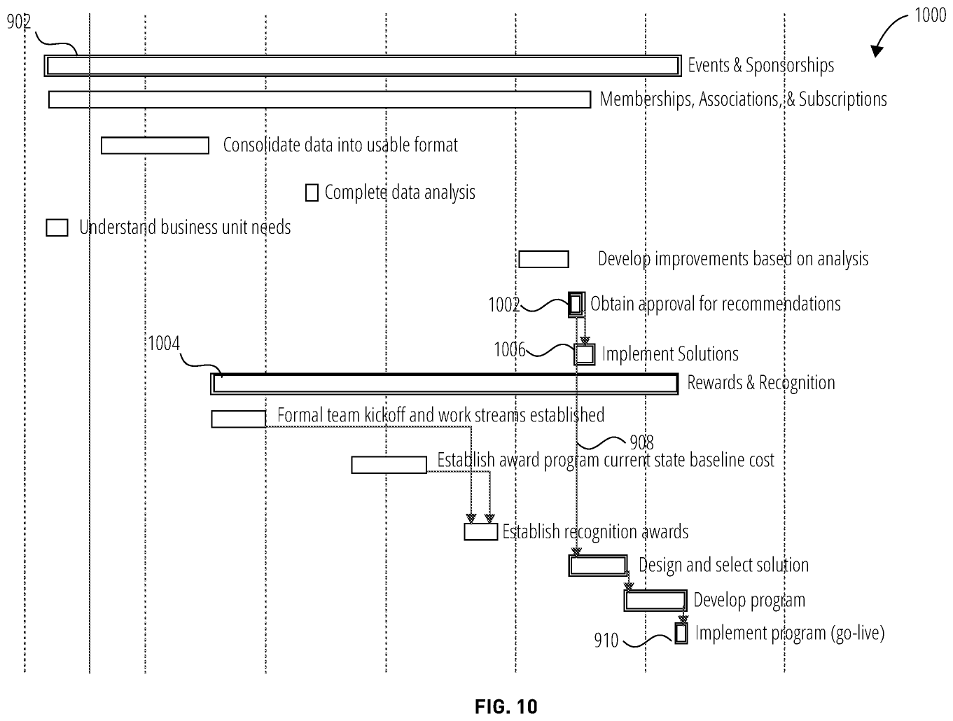

FIG. 10 illustrates a contrasted multi-domain critical element 1000 in accordance with one embodiment. In this example, both of the Events & Sponsorship parent target task 902 and the Rewards & Recognition parent target task 1004 are selected as the parent target tasks. Each of these domains has its own independent summary path contrasted and its own last-finisher child task (last-finisher child task 910 for Rewards & Recognition, and last-finisher child task 1006 for Events & Sponsorship).

Due to the domain spanning dependency 908 joining the two summary paths, the multi-domain critical task 1002 is critical to completion of both parent target tasks, and receives additional contrast or emphasis in the contrasted critical paths. The multi-domain critical task 1002 may be utilized for decision support and adjustment to the project plan. For example project management software may enable the allocation of physical resources to tasks. The project management software, under control of a human operator or on its own initiative (automatically), may adjust the resources allocated to the multi-domain critical task 1002 upward, in order to better ensure completion of the project on schedule. In another scenario the project management software or human operator may add slack time to the multi-domain critical task 1002, to remove it from the summary path of the two parent target task domains, or to make it non-critical.

By way of example, the summary path of one or more parent task may be applied to schedule execution of tasks in a machine system or a system including humans and machines, such that critical tasks common to multiple parent tasks have (i) an associated earliest start date, latest start date, earliest finish date, and/or latest finish date and/or period of execution in accordance with the established dependencies between each task, and/or (ii) for each task's respective time period, an associated process thread, storage, or other resource allocation enabling simultaneous execution of tasks and their respective threads for a given number of available process threads in the project/system, and wherein simultaneous execution of tasks occurs among tasks having no interdependencies therebetween. “Earliest finish date” refers to the earliest date that a task can be completed. “Latest start date” refers to the last date that a task can be started without shifting the parent task or project deadline. “Earliest start date” refers to the earliest date that a task can be started. “Latest finish date” refers to the last date that a task can be completed without shifting the parent task or project deadline. A last-finisher task is a task with a latest finish date among all sub-tasks of a parent task. Task execution may thus be optimized based on scheduling of tasks in the summary path(s), wherein optimizing task execution minimizes or otherwise improves efficiency of the system. In a typical scenario system resource allocation for tasks in the summary path may be increased.

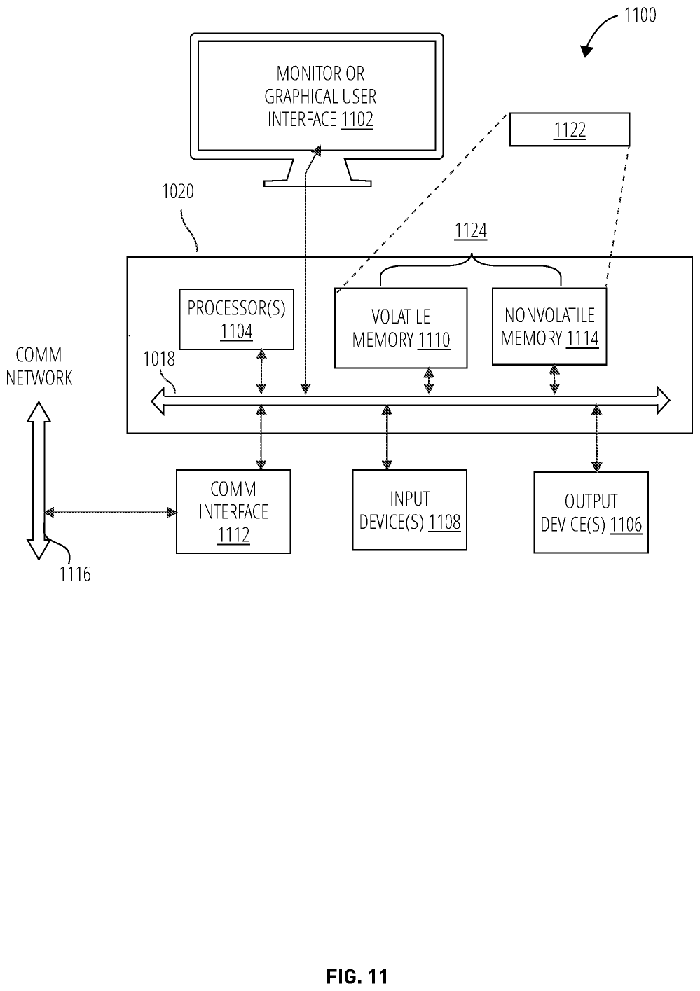

FIG. 11 is an example block diagram of a computing device 1100 that may incorporate embodiments of the present invention. FIG. 11 is merely illustrative of a machine system to carry out aspects of the technical processes described herein, and does not limit the scope of the claims. One of ordinary skill in the art would recognize other variations, modifications, and alternatives. In one embodiment, the computing device 1100 typically includes a monitor or graphical user interface 1102, a data processing system 1120, a communication network interface 1112, input device(s) 1108, output device(s) 1106, and the like.

The computing device 1100 may for example implement a scheduler for prioritizing a chain of tasks for performance by a system of one or more machines and/or people, by prioritizing a set of tasks utilizing the algorithms disclosed herein, and identifying one or more summary path in the structured project management user interface to indicate a higher-priority for tasks in the summary path than for tasks not in the summary path. The computing device 1100 may also in some cases be operated to increase a resource allocation of the system to the tasks in the summary path. When multiple parent tasks are selected for summary path generation, the computing device 1100 may determine a critical task common to multiple summary paths thus formed, and escalating the critical element for a highest priority in the set of multiple parent tasks.

As depicted in FIG. 11, the data processing system 1120 may include one or more processor(s) 1104 that communicate with a number of peripheral devices via a bus subsystem 1118. These peripheral devices may include input device(s) 1108, output device(s) 1106, a communication network interface 1112, and a storage subsystem, such as a volatile memory 1110 and a nonvolatile memory 1114.

The volatile memory 1110 and/or the nonvolatile memory 1114 may store computer-executable instructions and thus forming logic 1122 that when applied to and executed by the processor(s) 1104 implement embodiments of the processes disclosed herein for computing and displaying summary paths.

The input device(s) 1108 include devices and mechanisms for inputting information to the data processing system 1120. These may include a keyboard, a keypad, a touch screen incorporated into the monitor or graphical user interface 1102, audio input devices such as voice recognition systems, microphones, and other types of input devices. In various embodiments, the input device(s) 1108 may be embodied as a computing device mouse, a trackball, a track pad, a joystick, wireless remote, drawing tablet, voice command system, eye tracking system, and the like. The input device(s) 1108 typically allow a user to select objects, icons, control areas, text and the like that appear on the monitor or graphical user interface 1102 via a command such as a click of a button or the like.

The output device(s) 1106 include devices and mechanisms for outputting information from the data processing system 1120. These may include the monitor or graphical user interface 1102, speakers, printers, infrared LEDs, and so on as well understood in the art.

The communication network interface 1112 provides an interface to communication networks (e.g., communication network 1116) and devices external to the data processing system 1120. The communication network interface 1112 may serve as an interface for receiving data from and transmitting data to other systems. Embodiments of the communication network interface 1112 may include an Ethernet interface, a modem (telephone, satellite, cable, ISDN), (asynchronous) digital subscriber line (DSL), FireWire, USB, a wireless communication interface such as BlueTooth or WiFi, a near field communication wireless interface, a cellular interface, and the like.

The communication network interface 1112 may be coupled to the communication network 1116 via an antenna, a cable, or the like. In some embodiments, the communication network interface 1112 may be physically integrated on a circuit board of the data processing system 1120, or in some cases may be implemented in software or firmware, such as “soft modems”, or the like.

The computing device 1100 may include logic that enables communications over a network using protocols such as HTTP, TCP/IP, RTP/RTSP, IPX, UDP and the like.

The volatile memory 1110 and the nonvolatile memory 1114 are examples of tangible media configured to store computing device readable data and instructions to implement embodiments of the summary path processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1110 and the nonvolatile memory 1114 may be configured to store the basic programming and data constructs that provide the functionality of the summary path processes including embodiments thereof that fall within the scope of the present invention.

Logic 1122 that implements embodiments of summary path algorithms may be stored in the volatile memory 1110 and/or the nonvolatile memory 1114. Said logic 1122 may be read from the volatile memory 1110 and/or nonvolatile memory 1114 and executed by the processor(s) 1104. The volatile memory 1110 and the nonvolatile memory 1114 may also provide a repository for storing data used by the logic 1122.

The volatile memory 1110 and the nonvolatile memory 1114 may include a number of memories including a main random access memory (RAM) for storage of instructions and data during program execution and a read only memory (ROM) in which read-only non-transitory instructions are stored. The volatile memory 1110 and the nonvolatile memory 1114 may include a file storage subsystem providing persistent (non-volatile) storage for program and data files. The volatile memory 1110 and the nonvolatile memory 1114 may include removable storage systems, such as removable flash memory. The volatile memory 1110 and nonvolatile memory 1114 may comprise a computer-readable storage medium 1124 in which instructions are stored that, when executed, cause the computing device to implement the method disclosed herein.

The bus subsystem 1118 provides a mechanism for enabling the various components and subsystems of data processing system 1120 communicate with each other as intended. Although the communication network interface 1112 is depicted schematically as a single bus, some embodiments of the bus subsystem 1118 may utilize multiple distinct busses.

It will be readily apparent to one of ordinary skill in the art that the computing device 1100 may be a device such as a smartphone, a desktop computing device, a laptop computing device, a rack-mounted computing device system, a computing device server, or a tablet computing device. As commonly known in the art, the computing device 1100 may be implemented as a collection of multiple networked computing devices. Further, the computing device 1100 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

“Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

What is claimed is:

1. A scheduler for prioritizing a chain of tasks for performance by a system, the scheduler comprising:
a processor; and
a memory configured with instructions that when applied to the processor for execution, configure the processor to:
form a set of last-finisher child tasks of a first parent task displayed in a structured project management user interface;
determine a dependency graph for each child task in the set of last-finisher child tasks, wherein a task is added to the dependency graph on condition that it has a predecessor of zero slack;
for each dependent task in each of the dependency graphs, determine whether the dependent task is outside a domain boundary of the first parent task;
on condition that the dependent task is not outside the domain boundary, add the dependent task to a summary path for the first parent task; and
identify the summary path on the structured project management user interface to indicate a higher-priority for tasks in the summary path than for tasks not in the summary path.

2. The scheduler of claim 1, the instructions further configuring the processor to:
allocate machine or human resources based on the summary path.

3. The scheduler of claim 1, the instructions further configuring the processor to:
determine a summary path for a second parent task;
determining a critical task common to the summary path for the first parent task and the summary path for the second parent task; and
assign a highest priority to the critical task from among tasks of the first parent task and the second parent task.

4. The scheduler of claim 1, wherein the structured project management user interface is a Gantt chart.

5. The scheduler of claim 1, wherein the first parent task is updated recursively within the domain boundary.

6. The scheduler of claim 1, wherein the set of last-finisher child tasks is not constrained within the domain boundary.

7. A scheduler for prioritizing a particular task for performance by a system, the scheduler comprising:
a processor; and
a memory configured with instructions that when applied to the processor for execution, configure the processor to:
for each parent task from a set of multiple parent tasks selected using an input device from the structured project management user interface:
form a set of last-finisher child tasks for the parent task, the set of last-finisher child tasks not constrainted by a domain boundary of the corresponding parent task;
determine dependency graphs through zero slack paths leading from the parent task to each task in the set of last-finisher child tasks, the dependency graphs terminating at a domain boundary of any of the parent tasks;
on the structured project management user interface, forming a contrasted summary path based on the dependency graphs;
determining a critical task common to multiple summary paths thus formed; and
escalating the critical task to a highest priority in the set of multiple parent tasks.

8. The scheduler of claim 7, wherein generation of the multiple summary paths is activated by operating an input device on areas of the structured project management user interface corresponding to the set of multiple parent tasks.

9. The scheduler of claim 7, wherein each constrasted summary path has a different color scheme than for tasks not in the summary path.

10. The scheduler of claim 7, wherein the structured project management user interface is a Gantt chart.

11. A method of generating a contrasted visualization on a structured project management user interface, the method comprising:
forming a set of last-finisher child tasks of a first parent task displayed on the structured project management user interface;
determining a dependency graph for each task in the set of last-finisher child tasks, wherein a task is added to the dependency graph on condition that it has a predecessor of zero slack;
for each dependent task in each of the dependency graphs, determining whether the dependent task is outside a domain boundary of the first parent task;
on condition that the dependent task is not outside the domain boundary, adding the dependent task to a summary path for the first parent task; and
on condition that there are no more dependent tasks for any of the dependency graphs, contrasting a set of tasks forming the summary path on the structured project management user interface.

12. The method of claim 11, further comprising:
applying the summary path to re-allocate machine or human resources.

13. The method of claim 11, further comprising:
determining a summary path for a second parent task;
determining a critical task common to the summary path for the first parent task and the summary path for the second parent task; and
applying additional contrast emphasis to the critical task on the structured project management user interface.

14. The method of claim 11, wherein the structured project management user interface is a Gantt chart.

15. The method of claim 11, wherein the first parent task is updated recursively within the domain boundary.

16. The method of claim 11, wherein the set of last-finisher child tasks is not constrained within the domain boundary.

17. A method of generating a contrasted visualization on a structured project management user interface, the method comprising:
for each parent task from a set of multiple parent tasks selected using an input device from the structured project management user interface:
forming a set of last-finisher child tasks for the parent task;
determining dependency graphs through zero slack paths leading from the parent task to each task in the set of last-finisher child tasks, the dependency graphs terminating at a domain boundary of any of the parent tasks;
on the structured project management user interface, forming a contrasted summary path based on the dependency graphs;
determining a critical task common to multiple summary paths thus formed; and
distinguishing the critical task from other tasks in the multiple, contrasted summary paths.

18. The method of claim 17, further comprising assigning a highest priority to the critical task from among the tasks of the set of multiple parent tasks.

19. A method for scheduling a set of tasks for performance by a system, the method comprising:
forming a set of last-finisher child tasks of a parent task displayed in a structured project management user interface, wherein the set of last-finisher child tasks is not constrained within a domain boundary of the parent task;
determining a dependency graph for each child task in the set of last-finisher child tasks, wherein a task is added to the dependency graph on condition that it has a predecessor of zero slack;
for each dependent task in each of the dependency graphs, determining whether the dependent task is outside the domain boundary of the parent task;
on condition that the dependent task is not outside the domain boundary, adding the dependent task to a summary path for the parent task; and
on condition that there are no more dependent tasks for any of the dependency graphs, increasing a resource allocation of the system to the tasks in the summary path.

20. The method of claim 19, wherein generation of the summary path is activated from a context menu presented in response to a right click on the parent task.
